(19) United States
(12) Patent Application Publication
(10) Pub. No.: US 2025/0376225 A1
(43) Pub. Date: Dec. 11, 2025

(54) SPARE TIRE CARRIER SYSTEM WITH ANTI-THEFT FERRULE SHIELD

(71) Applicant: VENTRA GROUP, CO., Halifax, Nova Scotia (CA)

(72) Inventors: David DWORACZEK, Richmond Hill (CA); Terry HU, Markham (CA); Tim G. ROSSI, Bolton (CA)

(21) Appl. No.: 19/226,355

(22) Filed: Jun. 3, 2025

Related U.S. Application Data
(60) Provisional application No. 63/657,374, filed on Jun. 7, 2024.

(51) Int. Cl. B62D 43/00; B62D 43/04

(52) U.S. Cl. CPC B62D 43/007; B62D 43/04

(57) ABSTRACT

A vehicle tire carrier system for installation beneath a motor vehicle and protecting the wheel from unauthorized removal. The tire carrier system comprises: a raising and lowering mechanism comprising a cable and a rotational member for winding and unwinding the cable. A hub carrier is constructed to receive the wheel. The cable has a free end, and a ferrule is fixed to a free end portion of the cable. A rotatable cable end shield is mounted about the free end portion of the cable. The rotatable cable end shield comprises a housing having a top aperture in an upper portion thereof through which the free end portion of the cable is received. The housing encapsulates the free end portion of the cable and the ferrule for protection thereof. The rotatable cable end shield is configured to rotate independently to the free end portion of the cable and the ferrule.

### CROSS-REFERENCE TO RELATED APPLICATIONS

This application claims priority to U.S. Provisional Application No. 63/657,374, filed Jun. 7, 2024, the contents of which are hereby incorporated by reference in its entirety.

### FIELD

The present application relates to a tire carrier system for installation beneath a motor vehicle and supporting a spare vehicle wheel having a hub aperture, of the spare wheel.

### BACKGROUND

Tire hoist systems are commonly mounted under vehicle bodies. Examples of these systems are disclosed in U.S. patent application Ser. No. 17/724,100 published as US2022/0340215 A1, the entirety of which is incorporated herein. Such systems are used for storing a spare tire (a/k/a spare wheel, vehicle wheel) underneath the vehicle body, rather than including a spare tire compartment inside the vehicle. This is typical of pick-up trucks, which have limited space in the cab area. This is also typical in other vehicles as well, particularly for increasing interior cargo space (rather than allocating some of the internal space to a spare tire). With the spare wheel mounted outside of the vehicle cab, challenges arise with preventing the theft of the spare wheel.

### SUMMARY

One aspect of the present invention provides a vehicle tire carrier system for installation beneath a motor vehicle and supporting a vehicle wheel having a hub aperture and protecting the wheel from unauthorized removal. The tire carrier system comprises: a raising and lowering mechanism comprising a cable and a rotational member for winding and unwinding the cable. The rotational member is coupled to an actuator and configured to retract the cable in a raising direction and extend the cable in a lowering direction. A hub carrier is constructed to receive the wheel thereon. The cable has a free end, and a ferrule is fixedly attached to a free end portion of the cable. A rotatable cable end shield is mounted about the free end portion of the cable. The rotatable cable end shield comprises a housing having a top aperture in an upper portion thereof through which the free end portion of the cable is received. The housing encapsulates the free end portion of the cable and the ferrule for protection thereof by surrounding the free end portion of the cable in a circumferential direction and covering the free end portion of the cable. Also, the ferrule and the top aperture of the housing are configured to prevent withdrawal of the cable free end portion through the top aperture. The rotatable cable end shield is configured to rotate independently to the free end portion of the cable and the ferrule thereon.

Some aspects of the present invention provide a motor vehicle. The motor vehicle includes a spare vehicle wheel with a central hub aperture. To support the spare vehicle wheel, a tire carrier system is installed beneath the motor vehicle. As part of the tire carrier system, a raising and lowering mechanism including a cable, a rotational member, and an actuator is configured to retract the cable in a raising direction and extend the cable in a lowering direction. The tire carrier system additionally comprises a hub carrier for receiving the vehicle wheel thereon, the hub carrier having a center aperture. A ferrule is fixedly attached to a free end portion of the cable and a rotatable cable end shield is mounted about the free end portion of the cable. The rotatable cable end shield comprises a housing having a top aperture in an upper portion thereof through which the free end portion of the cable is received. The housing encapsulates the free end portion of the cable and the ferrule for protection thereof. The housing surrounds the free end portion of the cable and the ferrule in a circumferential direction and covers the free end portion of the cable. The ferrule and the top housing are configured to prevent withdrawal of the free end portion of the cable through the top aperture. The rotatable cable end shield is configured to rotate independently to the free end portion of the cable and the ferrule thereon.

Another aspect of the invention provides a method for assembling spare a tire carrier system with an anti-theft ferrule protection. The spare tire carrier system comprises: a hub carrier constructed to receive a tire thereon, having a center aperture and a raising and lowering mechanism. The raising and lowering mechanism comprises a cable; a rotational member; and an actuator, and is configured to retract the cable in a raising direction and extend the cable in a lowering direction. The spare tire carrier system additionally includes a ferrule and a rotatable cable end shield comprising a top housing portion having a top aperture, and a bottom housing portion.

The method comprises: feeding a cable through the center aperture of the hub carrier and the top aperture of the top housing; attaching a ferrule near the free end portion of the cable such that the ferrule prevents retraction of the cable through the top aperture of the top housing; fitting the bottom housing to the top housing such that the ferrule is disposed inside the rotatable cable end shield thereby closing off access to the ferrule; and securing the bottom housing to the top housing such that the ferrule is encapsulated inside the rotatable cable end shield and the bottom housing is permanently attached to the top housing to prevent removal of the ferrule from the rotatable cable end shield, the rotatable cable end shield being rotatable independently to the free end portion of the cable and the ferrule thereon.

Other aspects, features, and advantages of the present application will become apparent from the following detailed description, the accompanying drawings, and the appended claims.

### DESCRIPTION OF THE DRAWINGS

FIG. 1 is a perspective view of the tire carrier system in accordance with an embodiment of the invention;

FIG. 2 is an exploded view of the tire carrier system;

FIG. 3 is a perspective view of the tire carrier system in accordance with another embodiment of the invention;

FIG. 4 is a perspective view of the tire carrier system and a vehicle tire for reference;

FIG. 5A a is an exploded view of the anti-theft shield in accordance with an embodiment of the invention;

FIG. 5B is a perspective view of the anti-theft shield assembled without the rest of the tire carrier system shown;

FIG. 6A is an exploded view of the anti-theft shield in accordance with another embodiment of the invention;

FIG. 6B is a perspective view of the anti-theft shield assembled without the rest of the tire carrier system shown;

FIG. 7 is a cross section view of the rotatable ferrule shield;

FIG. 8 is an exploded view of an example raising and lowering mechanism to be used with the invention.

### DETAILED DESCRIPTION

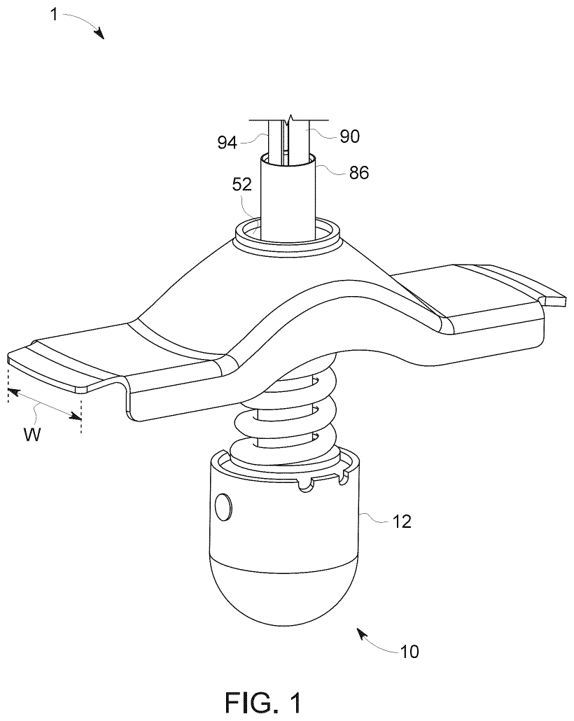

FIGS. 1-7 show views of a spare tire carrier system 1 in accordance with some embodiments of the present patent application. The construction of the remainder of the vehicle/motor vehicle, and the vehicle body thereof are not considered to be part of the present patent application and thus will not be detailed therein. Instead, the present patent application is concerned with the detail with the spare tire carrier system 1 having an anti-theft shield 10. In one embodiment, as will be discussed in detail below, the anti-theft shield 10 is a rotatable cable end shield 10. The rotatable cable end shield 10 may also be interchangeably referred to as the antitheft shield 10. The spare tire carrier system 1 may also be interchangeably referred to as the tire carrier system 1. The term anti-theft is not intended to be absolute, but rather should be interpreted in accordance with its commonsense meaning that the ability to steal the wheel 2 by breaking the cable 90 is reduced by making such a task more challenging. It is important to note, either cable 90 or cable 94 may be the main cable that is wound/unwound to raise and lower the spare tire and the other cable can be the secondary (e.g. safety) cable. Thus, the reference to cable 90 as the main cable and cable 94 as the secondary cable is not limiting and cable 94 can be the main cable and cable 90 can be the secondary cable.

The present application concerns an improved spare tire carrier system 1 mounted on vehicles for storing spare tires 2. The disclosed embodiment includes a protective device designed to prevent unauthorized access to and tampering with the ferrule 70 and main cable 90. The ferrule 70 is a generic structural term for any object attached to the cable's free end portion 92 to act as an enlarged end or stop feature to prevent it from being withdrawn through the top aperture 22 of the shield's 10 housing (discussed below). The ferrule 70 can be fastened to the cable free end portion 92 in any manner, including by clamping, crimping, fusing, welding, molding, threaded attachment, pinning, mechanical attachment, adhesive bonding, etc., and the structure of the ferrule 70 depicted is not intended to be limiting. This rotatable cable end shield 10 encapsulates the entire ferrule 70 and free end portion 92 of the cable 90, thereby mitigating the risk of damage or theft by making the crucial components less accessible and exposed. This construction enhances the security of the spare tire 2 by fortifying some vulnerable elements of the system 1, contributing to vehicle safety and owner peace of mind. Should the rotatable cable end shield 10 be grabbed and rotated, it would rotate independently of the ferrule 70. Thus, thieves cannot resort to breaking the cable 90 by twisting (in technical terms, applying torsional stress to the point of failure at its ultimate shear strength) because the shield 10 rotates independently of the cable 90 and ferrule 70. Similarly, the ferrule 70 and the top aperture 22 are configured to prevent withdrawal of the cable free end portion 92 through the top aperture 22, thus preventing its removal.

In addition to cable 90, some embodiments of the invention are used with an additional and optional safety cable 94. The safety cable 94 is also interchangeably referred to as a tether 94. The safety cable 94 is also fastened to the ferrule 70 at one end similar to the cable 90. The upper end of the safety cable 94 not fastened to ferrule 70 may be removably fastened to a location on the underbody of the vehicle. In these embodiments, the safety cable 94 functions to prevent complete lowering of the spare tire 2 in the event of an inadvertent lowering or unwinding of cable 90 or breaking thereof. The upper end of the safety cable 94 may also be connected to the main cable 90 at a point spaced from the free end. Thus, if cable 90 breaks from the ferrule 70, the safety cable 94 provides a back-up or secondary connection. In embodiments used with a safety cable 94, the rotatable cable end shield 10 protects both the cable 90 and the safety cable 94. The rotatable cable end shield 10 is free to rotate independent to the ferrule 70, thereby preventing twisting of the cable 90 and safety cable 94 when the rotatable cable end shield 10 is rotated.

The design allows the rotatable cable end shield 10 to rotate independently of other components, maintaining the operational integrity of the spare tire carrier system 1 without adding excessive weight or bulk. This construction not only provides a robust physical barrier but also maintains the operational integrity of the tire carrier system 1 while adding minimal weight and ensuring that the vehicle's undercarriage is not adversely impacted. The overall size of this invention also allows it to fit through the hub opening 3 of the spare tire 2, meaning the invention can be permanently fixed to the spare tire system 1 without ever needing to be removed.

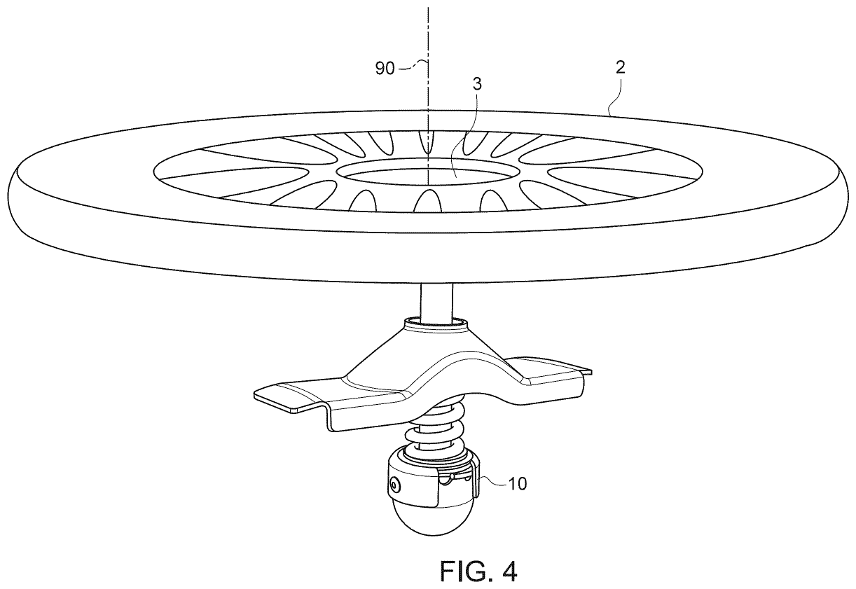

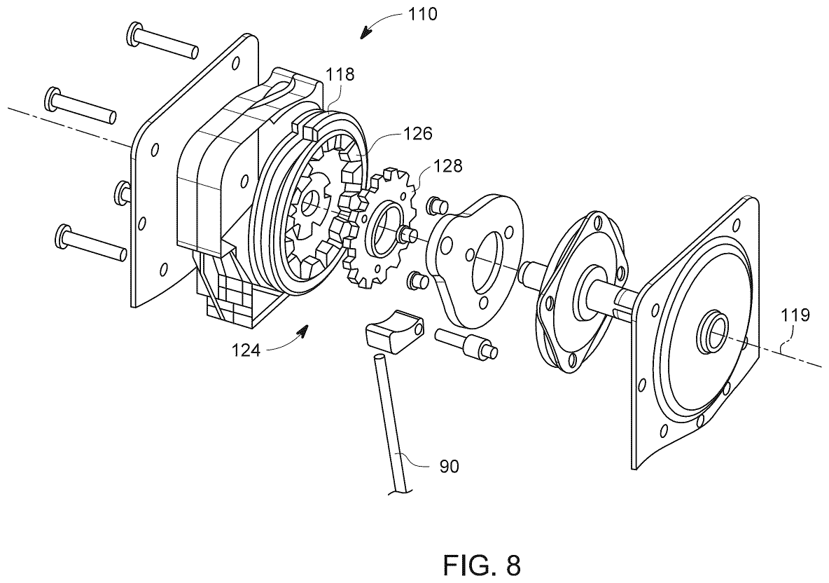

FIG. 4 shows the spare tire carrier system 1 in accordance with some embodiments with a vehicle wheel 2 raised off the hub carrier 50 for illustrative purposes. The tire carrier system 1 comprises: a raising and lowering mechanism 110, as shown in FIG. 8, comprising a cable 90 and a rotational member (e.g. take-up reel 118) for winding and unwinding the cable 90, the rotational member being coupled to an actuator (e.g. reduction gear system 124, such as may be driven by a manual drive tool, combinations of gear systems, etc.) and configured to retract the cable 90 in a raising direction and extend the cable 90 in a lowering direction. The term raising and lowering mechanism is a generic structural term for a class of mechanisms that raises and lowers the cable and is not limited to any particular construction. The design shown in FIG. 8 for the raising and lowering mechanism is one example to illustrate one type of raising and lowering mechanism, but the present application is not limited to such a design. A hub carrier 50 is constructed to receive the vehicle wheel 2 thereon. The hub carrier 50 as shown has an elongated shape designed to extend radially to support the tire 2 on the radially extending arms thereof, and the elongate shape also allows the carrier to be inserted in its long direction (e.g., about 90 degrees from the position shown in FIG. 4) through the hub aperture 3 of the spare vehicle wheel 2. The hub carrier 50 may have any construction or configuration for carrying the spare vehicle wheel 2 and the illustrated embodiment is not intended to be limiting.

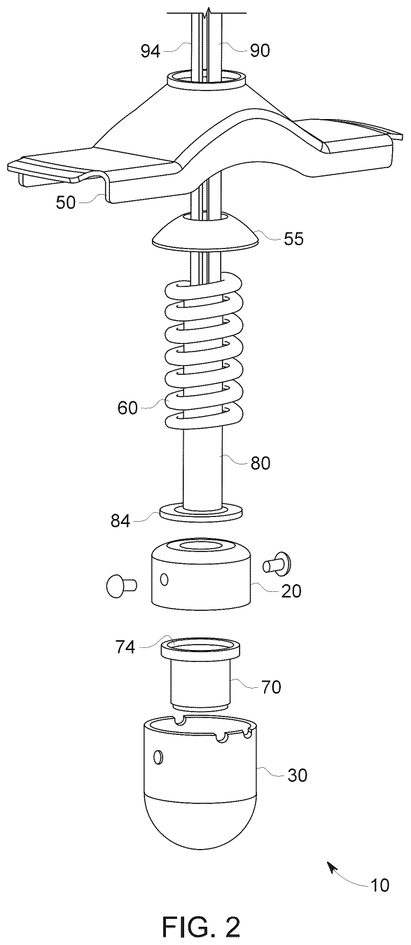

The spare tire carrier system 1, shown in FIGS. 1-7, may further comprise a shield tube 80 has bottom and top ends 84, 86 with a hollow structure and apertures at each end designed to allow the cable 90 to extend through the shield tube 80. and the hub carrier 50. The shield tube top end 86 is sized to fit through the center aperture of the hub carrier 50 so that the hub carrier 50 is slidably mounted on the shield tube 80 for axial movement over the shield tube 80. The shield tube 80 surrounds and protects a portion of the cable 90 extending upwardly and through the shield tube 80. In the shield tube 80 embodiment shown, the bottom end 84 is a circular flange extending radially from the shield tube 80 to serve as a base for biasing member 60. FIG. 2. shows an exploded view of some embodiments wherein biasing member 60 is sandwiched between bottom end 84 and spherical washer 55. Hub carrier 50 has a center aperture 52 sized smaller than spherical washer 55 so that hub carrier 50 is disposed on top of spherical washer 55.

The shield tube 80 may have any construction or configuration for protecting the cable 90 and optional safety cable 94 and the illustrated embodiment is not intended to be limiting. The shield tube 80 may, in the non-limiting illustrated embodiment, advantageously cooperate with the rotatable shield 10 by having its lower end 84 engaged against an upper portion 21 of the rotatable cable end shield 10 (e.g. direct contact or through a flat washer), thus shielding the portion of the cable 90 extending above the shield 10 when a tire is mounted thereon against cutting or the like by thieves. Various embodiments of the invention do not include a shield tube 80. In these embodiments, the cable 90 and any additional safety cable 94 used are protected by the biasing member 60. For example, the biasing member 60, in its compressed state, blocks access to cut the cable 90 or safety cable 94.

The spare tire system 1 also comprises the ferrule 70 fixedly attached to a free end portion 92 of the cable 90 and the rotatable cable end shield 10 mounted about the free end portion 92 of the cable 90 below the shield tube 80. The rotatable cable end shield 10 comprises a housing 12 designed to protect the free end portion 92 of the cable 90 and the ferrule 70 by surrounding the free end portion 92 of the cable 90 in a circumferential direction and being freely rotatable independent of the cable 90 and ferrule 70. The housing 12 of the rotatable cable end shield 10, shown in a non-limiting manner in FIGS. 1-7, comprises a top housing portion 20 and a bottom housing portion 30. The top housing has a top aperture 22 in an upper portion thereof through which the free end portion 92 of the cable 90 is received. The housing 12 encapsulates the free end portion 92 of the cable 90 and the ferrule 70 when the bottom housing portion 30 is attached to the top housing portion 20. As mentioned previously, the ferrule 70 is larger than the top aperture 22 of the housing 12 to prevent withdrawal of the ferrule through the top aperture 22. That is, in the cross-sectional direction (taken perpendicular to the vertical direction in the Figures) the ferrule 70 is oversized, e.g., of larger diameter, to prevent such withdrawal. The rotatable cable end shield 10 is also sized to fit through the hub aperture 3 of the vehicle wheel 2 such that the vehicle wheel 2 is able to be removed from the tire carrier system 1 without removing the rotatable cable end shield 10. The rotatable cable end shield 10 may have any construction or configuration for being rotatably mounted to rotate independently to the free end portion 92 of the cable 90 and the ferrule 70 and the illustrated embodiment is not intended to be limiting.

The rotatable cable end shield 10 has an opening 22 in the upper portion 21 to allow the cable 90 and optional safety cable 94 to pass through but not the ferrule 70, thereby encapsulating the ferrule 70, cable free end portion 92, and the free end of optional safety cable 94 and preventing access to, or tampering with, the ferrule 70. For example, in the event of attempted tampering with the ferrule 70 by twisting the rotatable cable end shield 10, the rotatable cable end shield 10 would rotate independently of the ferrule 70 and prevent tampering with the ferrule 70. By rotatably mounting the rotatable cable end shield 10, the spare tire carrier system 1 prevents dislodging of the spare tire 2 by gripping and twisting the ferrule 70, causing the main cable 90 to twist and ultimately fail.

The rotatable cable end shield 10 is sized to fit through the hub aperture 3 of the vehicle wheel 2 such that the vehicle wheel 2 is able to be removed from the tire carrier system 1 without removing the rotatable cable end shield 10. When, for example, a user goes to properly remove the wheel 2 from the vehicle by unwinding the cable 90 and lowering the vehicle wheel 2, the rotatable cable end shield 10 is sized to fit through the center hub opening 3 in the vehicle wheel 2 such that the vehicle wheel 2 can be removed without removing the permanently attached rotatable cable end shield 10.

FIG. 8 shows an exploded view of an example embodiment raising and lowering mechanism 110. In some embodiments, the raising and lowering mechanism 110 comprises a take-up reel 118 rotatable about a reel axis 119 and a cable 90. The cable 90 is coupled to the take-up reel 118 so that the rotation of the take-up reel 118 either takes up or pays out the cable 90 for raising or lowering the spare vehicle wheel 2. To operate the take-up reel 118, a user provides input torque to a reduction gear system 124 that acts as the actuator to operate the take-up reel 118 for raising or lowering the vehicle wheel 2. For example, the rotation of a manual drive tool engaged with the reduction gear system 124 causes the take-up reel 118 to rotate. The reduction gear system 124 comprises an input gear 128 engageable by the drive tool and an output gear 126 rotatable about an axis parallel to the reel axis 119. In various embodiments, the input gear 128 is meshed directly with the output gear 126. In other embodiments, the input gear 128 and output gear 126 are engageable through intermediate gear systems. The structure and operation of the raising and lowering mechanism 110 is described in further detail in, for example, U.S. patent application Ser. No. 17/948,708, published as US2023/0091322A1, and the disclosure of said application is hereby incorporated by reference in its entirety into the present application. The raising and lowering system may have a manually operated actuator for rotating the rotational member to raise and lower the cable, such as by a manual drive tool (often included or combined with the same set of tools using to operate the vehicle jack), or a powered actuator, such as one with an electric motor, hydraulic motor, or a mechanically driven input from a power source such as engine driven power (e.g., driven by a belt, chain or transfer shaft). Thus, the design of the raising and lowering mechanism 110 is not limited to any particular type of raising and lowering mechanism.

Operation of the raising and lowering mechanism 110 is generally limited to authorized users (e.g. requires special tool or access to locked cab). Basic wheel removal operation of the spare tire carrier system 1 involves operating the raising and lowering mechanism 110 to pay out enough cable 90 to lower the wheel 2 to the ground. From there, the user typically angles the hub carrier 50 through the hub aperture 3 of the vehicle wheel 2 so that it can be withdrawn therefrom. Accordingly, the width W of the hub carrier 50 is sized to fit through the hub aperture 3. The width W of the hub carrier 50 is measured across the short side of the hub carrier 50. The vehicle wheel 2 may then be removed from the spare tire carrier system 1 by withdrawing the remainder of the shield tube 80 and rotatable cable end shield 10 out through the hub aperture 3 of the wheel 2. The particular order of operation is not intended to be limiting, but this is the general process for context, as most users lower the tire to the ground to relieve weight before attempt to withdraw the carrier 50 and other components on the cable end 92. Some users may pay out a substantial amount of the cable 90 so the wheel 2 can be pulled out from beneath the vehicle to make this process easier, although the amount of pay out may vary from vehicle to vehicle.

In order to remain permanently attached to the cable 90 during removal of the vehicle wheel 2, the rotatable cable end shield 10, fits through the hub aperture 3 of the vehicle wheel 2. The rotatable cable end shield 10 is sized to fit through the hub aperture 3 of the vehicle wheel 2 such that the vehicle wheel 2 is able to be removed from the tire carrier system 1 without removing the rotatable cable end shield 10. When, for example, a user goes to properly remove the wheel 2 from the vehicle by unwinding the cable 90 and lowering the vehicle wheel 2, the rotatable cable end shield 10 is sized to fit through the center hub aperture 3 in the vehicle wheel 2 such that the vehicle wheel 3 can be removed without removing the permanently attached rotatable cable end shield 10. In some embodiments, the width of the rotatable cable end shield 10 is sized smaller than the width W of the hub carrier 50. For example, the horizontal distance across the rotatable cable end shield 10 is less than the width W of the hub carrier 50 (i.e. the horizontal distance across the hub carrier when looking at the shorter edge). Sizing the rotatable cable end shield 10 smaller than the width W of the hub carrier 50 assist in the removal operation by reducing the amount of additional manipulation of the tire required to pull the cable end shield 10 through the hub aperture 3 after pulling the hub carrier 50 through the hub aperture 3.

In some embodiments, the width W of the hub carrier 50 is sized to allow the hub carrier 50 to fit through a hub aperture 3 at least 72.6 mm in diameter in the vehicle wheel 2. In some embodiments, the width W of the hub carrier 60 is sized to fit through a hub aperture 3 at least 54.1 mm in diameter. The size is not intended to be limiting, and any selection of sizes for width W may be used to ensure the end hub carrier 50 can fit through the hub aperture 3 of the spare vehicle wheel 2 to be carried, which may vary between different vehicles.

In some embodiments, the housing 12 of the rotatable cable end shield 10 includes the top aperture 22 disposed above a ferrule 70 for a cable 90 to pass through. The top aperture 22 is configured so that the ferrule 70 cannot be readily removed through the top aperture 22, thereby encapsulating the ferrule 70 in the rotatable cable end shield 10. For example, the top aperture 22 is circular with a diameter sized to allow a cable 90 to pass through but not allow withdrawal of the ferrule 70 from the housing 12 through the top aperture 22. In some embodiments, the top aperture 22 is disposed between the shield tube 80 and the ferrule 70 wherein the rotatable cable end shield 10 is capable to rotate independent of the ferrule 70.

In some embodiments, the cable 90 is a flexible cable (e.g. multiple strand or single strand). In some embodiments, the cable 90 is made of metal material (e.g. stainless steel, mild steel) or it may be made from another material. Additionally, the cable 90 may comprise safety cable 94. For example, one end of safety cable 94 is fixed at a point along cable 90 and the other end of safety cable is a free end attached to the ferrule 70. In another embodiment, the cable 90 comprises a chain structure (e.g. chain linkage). In yet another embodiment, the cable 90 includes a rigid portion or attachment, such as at the free end thereof. Thus, the term cable includes cables formed by strands as well as links connected together to form a chain as well as other such flexible elongated members that are wound and unwound for raising and lowering.

In some embodiments, the housing 12 of the rotatable cable end shield 10 for the spare tire carrier system 1 in the vehicle includes a top housing portion 20 and a bottom housing portion 30. The top housing portion 20 includes the top aperture 22 and is configured to sit directly above the ferrule 70. Access to the cable 90 and the top aperture 22 from the top side 74 of the ferrule 70 is blocked by a shield tube 80. The cable 90 passes through the top aperture 22 and through the shield tube 80. The bottom housing portion 30 is coupled to the top housing 20 thereby covering access to the ferrule 70 from the bottom side to prevent direct access to the ferrule 70 and cable 90.

In other embodiments, the housing 12 includes a bottom housing portion 30 and no separate, dedicated top housing portion 20. Instead, the shield tube 80, having a shield tube aperture, serves the function of the top aperture 22. For example, the shield tube aperture is circular with a diameter sized to allow a cable 90 to pass through but not allow withdrawal of the ferrule 70 through the shield tube aperture. In this case, the shield tube 80 may be considered part of the housing 12 of the rotatable cable end shield 10 and the shield tube aperture provides the upper portion 21 and the top aperture 22 of the housing 12. The bottom housing 30 is coupled to the shield tube 80 (e.g. to the bottom end 84) thereby encapsulating and covering access to the ferrule 70 and cable 90 and wherein the bottom housing portion 30 is capable to rotate independent of the ferrule 70. Specifically, the bottom housing portion 30 may be rotatably coupled to the shield tube 80 (e.g. groove connection) and capable to rotate independent the ferrule 70 and the shield tube 80, or the bottom housing portion 30 is a fixed connection to the shield tube 80 and both are capable to rotate together, independent of the ferrule 70. Either capability is considered independent rotation of the cable 90 and rotatable cable end shield 10.

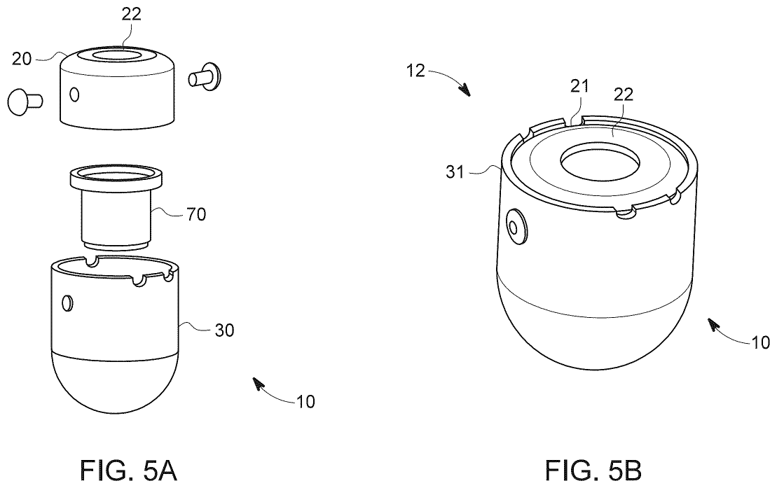

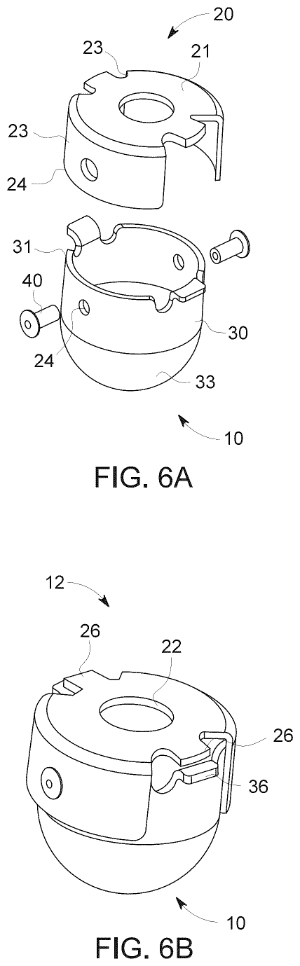

FIGS. 5A and 6A show an exploded view of two different rotatable cable end shields 10 in accordance with some embodiments of the present patent application. The housing 12 has an upper portion 21 that is substantially planar in each embodiment. As in the illustrated embodiments, where the housing 12 comprises a top housing portion 20, the upper portion 21 is part of the top housing portion 20. The top aperture 22 is located on the upper portion 21 of the top housing portion 20 (e.g. in the center). One or more flange portions 23 extend downward from the edge or edges of the upper portion 21 for receiving the bottom housing portion 30.

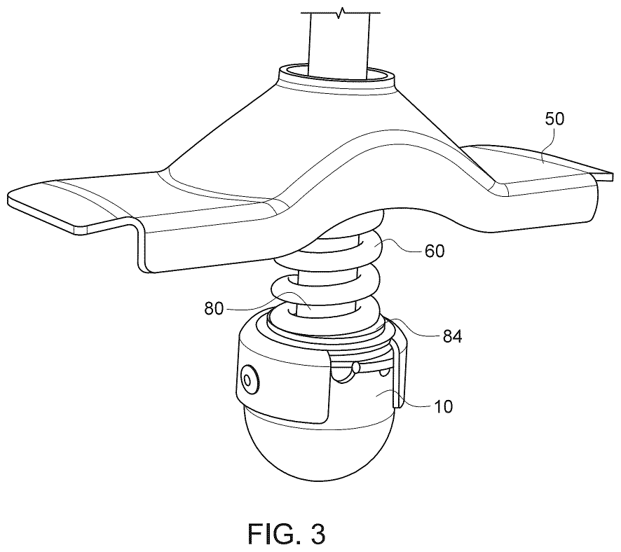

In some embodiments, the flange portion 23 is one continuous flange that extends downward from entire edge of the upper portion 21 as illustrated in FIGS. 1-2 and FIGS. 5A-5B. In other embodiments, two flange portions 23 extend downward from opposite edges of the upper portion 21 as illustrated in FIGS. 3-4 and FIGS. 6A-7. The flange portion 23 has features for fastening or coupling the top housing portion 20 and bottom housing portion 30. For example, the flange portion 23 may have one or more fastener apertures 24 for fasteners 40 (e.g. blind rivets, screws, pins). Additionally, the top housing portion 20 and bottom housing portion 30 may have one or more alignment tabs 26, 36 as shown in the embodiment illustrated in FIGS. 3-4 and FIGS. 6A-7. The alignment tabs 26, 36 assist with aligning the fastener apertures 24 on the top housing portion 20 and bottom housing portion 30 during assembly. The alignment tabs 26, 36 are disposed on the upper portion 21 of the top housing portion 20 and the upper portion 31 of the bottom housing portion 30 as illustrated in FIGS. 6A-6B. The location of the alignment tabs hides 26, 36 and minimizes any gap between the two alignment tabs 26, 36. In other examples, the flange portions 23 are bonded to the bottom housing portion 30 (e.g. welded, spot welded, brazed, glued). In some embodiments, the top housing portion 20 and bottom housing portion 30 may snap lock together without access to un-snap the bottom housing portion 30 from the top housing portion 20 (e.g. one time assembly where disassembly requires substantial damage to the rotatable cable end shield 10).

In some embodiments, the bottom housing portion 30 has an upper portion 31 for mating with the top housing portion 20 and a bottom portion 33. The bottom portion 33, for example, preferably has a dome shaped structure to reduce the overall footprint of the rotatable cable end shield 10 and offer less structure for a thief to access. In various embodiments the bottom portion 33 may vary from the dome shape to accommodate vehicle specific size constraints and still be in accordance with the present invention. The distal end of the bottom portion 33 has a drain aperture 32 for water drainage to prevent corrosion of the shield 10, ferrule 70, and cable 90. Specifically, the drain aperture 32 diameter is small enough to prevent access to the ferrule 70, cable 90, or free end portion 92 of cable 90 through the hole (e.g. less than the width or diameter of the ferrule 70, less than the diameter of the cable 90).

In some embodiments, the tire carrier system 1 comprises a biasing member 60. The biasing member 60 is a structural term for an object (e.g., a spring) with an elastic or dampening feature to provide shock absorption of the load of the wheel 2 while the wheel 2 is in the raised position and the vehicle is in motion. The biasing member 60 may be disposed in a location between the hub carrier 50 and the bottom end 84 of the shield tube 80 in order to reduce a jerk or shock load to the shield tube 80, rotatable cable end shield 10, cable 90, and ferrule 70. The spherical washer 55 may be disposed between the biasing member 60 and the hub carrier 50 to keep the biasing member properly aligned and maintain more even contact with the hub carrier 60. Use of the spherical washer 55 may also reduce friction between hub carrier 50 and biasing member 60. The bottom end 84 of the shield tube 80 has a circular flange structure for receiving one end of the biasing member 60. The tire carrier system 1 additionally comprises: a raising and lowering mechanism 110 as discussed above comprising a cable 90 and a rotational member for winding and unwinding the cable 90. The hub carrier 50 is slidably mounted on the shield tube 80 for axial movement over the shield tube 80. For example, varying loads from the vehicle wheel 2 and hub carrier 50 caused by the vehicle traveling over uneven surfaces may result in compression of the biasing member 60 and axial sliding of the vehicle wheel 2 and hub carrier 50 relative to the shield tube 80, ferrule 70, cable 90, and rotatable cable end shield 10.

The top aperture 22 of the rotatable cable end shield 10 is disposed between the bottom end 84 of the shield tube 80 and the ferrule 70 while the biasing member 60 pushes the bottom end 84 of the shield tube 80 against the rotatable cable end shield 10 and away from the hub carrier 50. The compression of the rotatable cable end shield 10 between the bottom end 84 of the shield tube 80 and the ferrule 70 is such to provide support to the rotatable cable end shield 10 while still allowing the rotatable cable end shield 10 to rotate independently of the ferrule 70 and the cable 90. In some embodiments, the bottom end 84 of the shield tube 80 is a circular flange with a flat face and the ferrule 70 has a flat portion that is in contact with the underside of the housing upper portion 21 of the rotatable cable end shield 10 to reduce sliding resistance. Optional washers may also be included to reduce sliding resistance.

FIG. 5B shows a view of the assembled rotatable cable end shield 10 in accordance with some embodiments of the invention, other components of the spare tire carrier system 1 are not shown with the assembled rotatable cable end shield 10 in FIG. 5B for illustrative purposes. The bottom housing portion 30 and top housing portion 20 are mated together, thereby encapsulating the ferrule 70. For example, during assembly, the cable 90 is fed through the top aperture 22 in the top housing portion 20 before installing the ferrule 70 (e.g. screwing, crimping) near the free end portion 92 of the cable 90. In some embodiments, the cable 90 is fed through a shield tube 80 before being fed through the top aperture 22. After the ferrule 70 is installed onto the cable 90, the bottom housing portion 30 is fitted over the top housing portion 20 (e.g. overlapping the outside of the flange portion 23 of the top housing portion 20) thereby encapsulating the ferrule 70. Specifically, the upper edge 31 of the bottom housing portion 30 is disposed near the upper portion 21 of the top housing portion 20 so the bottom portion 30 covers the flange portion 23 (e.g. upper edge 21 is disposed on substantially the same plane as upper portion 21). One instance of this configuration is illustrated in FIG. 5B. While the bottom housing portion 30 fitting around the outside of the top housing portion 20 is preferable for tamper resistance (e.g. prying apart), it should be noted that, in some embodiments, the bottom housing portion 30 fits inside (e.g. inside of the flange portion 23) the top housing portion 20 and still is in accordance with the invention. Then, the top housing portion 20 and bottom housing portion 30 are fastened together with one or more fasteners 40 (e.g. rivets, screws, pins). However, with the approach of FIG. 5B separation of the housing portions 20, 30 by a thief attempting to pry them apart is more difficult because any space where a prying tool could be inserted will be up near the hub carrier 50 and/or covered by the bottom end 84 of the shield tube 80, which is compressed downward by the biasing member 60.

In some or more embodiments, as shown in FIGS. 6A and 6B, the one or more alignment tabs 26 on the top housing portion 20 are then aligned with the one or more alignment tabs 36 on the bottom housing portion 30. When the bottom housing portion 30 is fully fitted into the top housing portion 20 and rotated to align the alignment tab 26 on the top housing portion 20 with the alignment tab 36 on the bottom housing portion 30, the one or more fastener apertures 24 are aligned for fastening. Then, the top housing portion 20 and bottom housing portion 30 are fastened together with one or more fasteners 40 (e.g. rivets, screws, pins).

In some embodiments, the invention provides a method for assembling a spare tire carrier system 1 with an anti-theft ferrule protection. The spare tire carrier system 1 comprises: the hub carrier 50 having a center aperture 52; the optional shield tube 80 having a bottom end 84; the cable 90 having the free end portion 92; the ferrule 70; and the rotatable cable end shield 10 comprising the top housing portion 20 having the top aperture 22, the bottom housing portion 30, and at least one fastener 40.

The method comprises: providing the cable 90 through the center aperture 52 of the hub carrier 50, the shield tube 80, and the top aperture 22 of the top housing portion 20; attaching a ferrule 70 near the free end portion 92 of the cable 90 such that the ferrule 70 contacting the rotatable cable end shield 10 prevents retraction of the cable 90 through the top aperture 22 of the top housing portion 20. The bottom housing portion 30 is fitted to the top housing portion 20 such that the ferrule 70 is disposed inside the rotatable cable end shield 10 thereby closing off access to the ferrule 70. The bottom housing portion 30 is secured to the top housing portion 20 such that the bottom housing portion 30 is permanently attached to the top housing portion 20 and the ferrule 70 cannot be removed from the rotatable cable end shield 10. The rotatable cable end shield 10 is thus free to rotate independently of the ferrule 70.

In some embodiments, the securing of the bottom housing portion 30 to the top housing portion 20 is carried out by fastening the bottom housing portion 30 to the top housing portion 20 with at least one fastener 40.

In some embodiments, the top and bottom housing portion 30 are one combined piece, and the top aperture 22 comprises a deformable member to allow installation over the ferrule 70 (e.g. initial installation, permanent installation, snap-on installation requiring special tools to remove). As an example, the top aperture 22 is defined by deformable members that deform in one direction allowing the top aperture 22 to expand to push over the ferrule 70, but not allow deformation of the top aperture to pull back off of the ferrule 70.

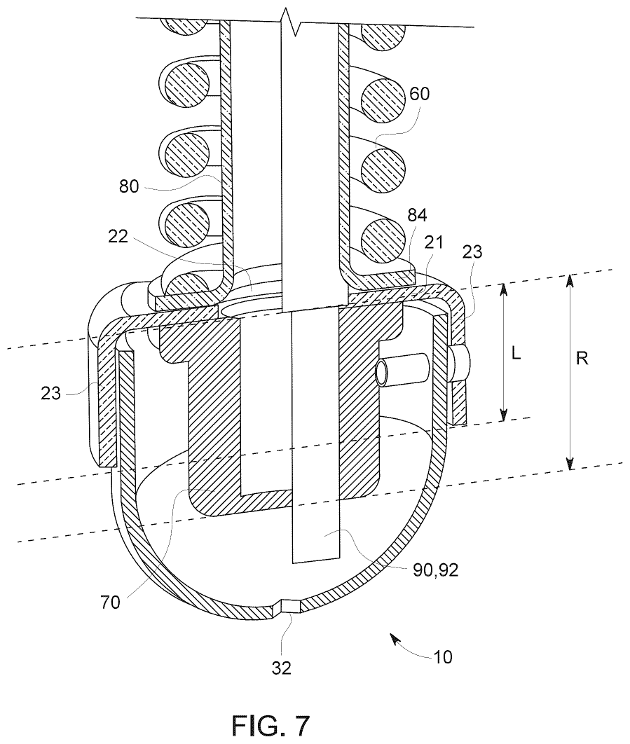

FIG. 7 shows a cross section view of the rotatable cable end shield 10 assembled on the spare tire carrier system 1 in accordance with some embodiments, particularly that of FIGS. 6A-6B. A portion of the top housing portion 20 is disposed between the bottom end 84 of the shield tube 80 and the ferrule 70. It should be understood that the structure of the bottom end 84 of the shield tube 80, the top housing portion 20, and the ferrule 70 are such that the rotatable cable end shield 10 may rotate independent of the ferrule 70, the cable 90, and an optional safety cable 94. For example, the bottom end 84 of the shield tube 80 may include a tube flange and contact the top housing portion 20 along a flat surface and the top housing portion 20 is in contact with the ferrule 70 along a flat surface (e.g. multiple flat surfaces, parallel surfaces, low friction surfaces) to reduce friction and allow the pieces to slide against each other before enough torque is applied to damage the cable 90. In some embodiments, the rotatable cable end shield 10 and shield tube 80 rotate together and independent of the ferrule 70 and cable 90.

In other embodiments, the rotatable cable end shield 10 may be structured where the rotatable cable end shield 10 or some portion thereof does not rotate independently of the ferrule 70. For example, a portion of the rotatable cable end shield 10 may be attached to the ferrule 70 while the rest of the rotatable cable end shield 10 may rotate independent of the ferrule 70 to prevent twisting of the ferrule 70. For example, the portion of the rotatable cable end shield 10 attached to the ferrule 70 may contact the rotatable portion of the rotatable cable end shield 10 along a flat surface (e.g. multiple flat surfaces, parallel surfaces, low friction surfaces) to reduce friction and allow the pieces to slide against each other. In other examples, the portion of the rotatable cable end shield 10 attached to the ferrule 70 may attach to the rest of the rotatable cable end shield 10 through a breakaway portion. The breakaway portion is designed to fail under loads that would cause damage to the ferrule 70 or cable 90. For example, if a thief attempted to grip and twist the rotatable cable end shield 10, the breakaway portion of the rotatable cable end shield 10 would fail and allow the rotatable cable end shield 10 thereafter to rotate independent of the ferrule 70 while still encapsulating the ferrule 70, thus preventing the thief from gripping and twisting the ferrule 70. Thus, while the illustrated embodiment shows a design where the shield 10 is rotatably mounted, and thus always able to rotate, in some designs the configuration enabling rotating may be by a design where rotation happens after sufficient torque is applied to the shield 10.

In some embodiments, the rotatable cable end shield 10 still provides a level protection to the ferrule 70 even after some malicious tampering has occurred. In the embodiment shown in FIGS. 6A-7, in the event a thief has successfully separated the bottom housing portion 30 from the top housing portion 20, the one or more flange portions 23 of the top housing portion 20 may prevent gripping and twisting of the ferrule 70, or at least make it more challenging for thief because access to the ferrule 70 remains difficult. Referring to FIG. 7, the one or more flange portions 23 extend downward from the upper portion 21 of the top housing portion 20, thereby blocking side access to the ferrule 70, which may make it more difficult for a thief to grab the ferrule with pliers or the like for twisting the cable 90. For example, the one or more flange portions 23 extend in a downward direction a total distance L from the upper portion 21. In some embodiments, the distance L is at least half a distance R of the ferrule 70 to prevent side access for twisting. The distance R is measured from the upper portion 21 to a distal end of the ferrule 70. In another embodiment, the one or more flange portions 23 extend a distance L1 at least the entire distance R of the ferrule 70 to prevent side access for twisting.

It should be noted that the application uses terms like anti-theft, preventing, precluding, permanent attachment or other such terms that indicate an ability to avoid theft of the wheel 2 by breaking the cable 90. Such terms are not intended to be absolute, but rather should be interpreted in accordance with their commonsense meaning that the ability to steal the wheel 2 by breaking the cable 90 is reduced by making such a task more challenging. With prior systems, the ferrule is not well protected and thieves can break the cable by twisting, which for thieves also has the advantage of being a generally quieter approach requiring a smaller tool, such as pliers or a similar device, to grab the ferrule to twist the cable 90. The present application makes such access more difficult and any attempted theft requires more work, and likely makes more noise as breakage and removal of the shield 10 is required. The ability to prevent theft may also arise from the deterrent effect of the thief seeing the device and choosing to move on to an easier target. Thus, absolute theft prevention is not intended to be interpreted into any terms in an absolute manner.

Although the present patent application has been described in detail for the purpose of illustration, it is to be understood that such detail is solely for that purpose and that the present patent application is not limited to the disclosed embodiments, but, on the contrary, is intended to cover modifications and equivalent arrangements that are within the spirit and scope of the appended claims. In addition, it is to be understood that the present patent application contemplates that, to the extent possible, one or more features of any embodiment can be combined with one or more features of any other embodiment.

The illustration of the embodiments of the present patent application should not be taken as restrictive in any way since a myriad of configurations and methods utilizing the present patent application can be realized from what has been disclosed or revealed in the present patent application. The systems, features and embodiments described in the present patent application should not be considered as limiting in any way. The illustrations are representative of possible construction and mechanical embodiments and methods to obtain the desired features. The location and/or the form of any minor design detail or the material specified in the present patent application can be changed and doing so will not be considered new material since the present patent application covers those executions in the broadest form.

The foregoing illustrated embodiments have been provided to illustrate the structural and functional principles of the present patent application and are not intended to be limiting. To the contrary, the present patent application is intended to encompass all modifications, alterations and substitutions within the spirit and scope of the appended claims.

What is claimed:

1. A tire carrier system for installation beneath a motor vehicle and supporting a spare vehicle wheel having a hub aperture, the system comprising:
a raising and lowering mechanism comprising a cable and a rotational member for winding and unwinding the cable, the rotational member being coupled to an actuator and configured to retract the cable in a raising direction and extend the cable in a lowering direction;
a hub carrier constructed to receive the vehicle wheel thereon;
a ferrule fixedly attached to a free end portion of the cable;
a rotatable cable end shield mounted about the free end portion of the cable, the rotatable cable end shield comprising a housing having a top aperture in an upper portion thereof through which the free end portion of the cable is received, the housing encapsulating the free end portion of the cable and the ferrule for protection thereof by surrounding the free end portion of the cable in a circumferential direction and covering the free end portion of the cable, wherein the ferrule and the top aperture of the housing are configured to prevent withdrawal of the cable free end portion through the top aperture;
wherein the rotatable cable end shield is configured to rotate independently to the free end portion of the cable and the ferrule thereon.

2. The vehicle tire carrier system of claim 1, wherein the housing of the rotatable cable end shield comprises a top housing portion and a bottom housing portion, the bottom housing portion being permanently attached to the top housing portion and the top housing portion comprising the upper portion of the housing with the top aperture.

3. The vehicle tire carrier system of claim 2, wherein the bottom housing portion is disposed around the outside of the top housing portion.

4. The tire carrier system of claim 3, wherein the bottom housing comprises a top edge, the top edge disposed on substantially the same plane as the upper portion.

5. The vehicle tire carrier system of claim 2, wherein the top housing portion comprises a flange portion, the flange portion extending down from the upper portion, wherein the bottom housing is disposed around the outside the top housing portion.

6. The vehicle tire carrier system of claim 5, wherein the flange portion is one continuous flange portion.

7. The vehicle tire carrier of claim 6, wherein the bottom housing comprises a top edge, the top edge disposed near the upper portion thereby covering the flange portion.

8. The vehicle tire carrier of claim 2, wherein the top and bottom housing portions are permanently attached by at least one fastener.

9. The tire carrier system of claim 1, wherein the system comprises a shield tube, the cable extending through the shield tube and the hub carrier being slidably mounted on the shield tube for axial movement over the shield tube.

10. The tire carrier system of claim 9, wherein the shield tube is configured to surround and protect a portion of the cable extending upwardly from the rotatable cable end shield and through the shield tube.

11. The tire carrier system of claim 10, wherein the bottom end of the shield tube includes a radially extending flange positioned to contact the upper portion of the housing, the system further comprising a biasing member in contact with a top surface of the flange and disposed between the top surface of the flange and the hub carrier for absorbing vertical motion of the spare vehicle wheel when on the hub carrier.

12. The tire carrier system of claim 2, wherein the bottom housing portion includes a dome shape.

13. The tire carrier system of claim 2, wherein the bottom housing portion includes a drain aperture disposed below the ferrule.

14. The tire carrier system of claim 1, wherein the width of the rotatable cable shield is less than the width of the hub carrier.

15. The tire carrier system of claim 14, wherein the hub carrier is sized to fit through a 72.6 mm aperture such that the vehicle wheel is able to be removed from the tire carrier system without removing the rotatable cable shield.

16. The tire carrier system of claim 1, wherein the cable shield is rotatably mounted to rotate independently to the free end portion of the cable and the ferrule thereon.

17. A motor vehicle comprising:
a spare vehicle wheel having a hub aperture;
a tire carrier system installed beneath the motor vehicle and supporting the spare vehicle wheel:
a raising and lowering mechanism comprising a cable and a rotational member for winding and unwinding the cable, the rotational member being coupled to an actuator and configured to retract the cable in a raising direction and extend the cable in a lowering direction;
a hub carrier with the vehicle wheel received thereon;
a ferrule fixedly attached to a free end portion of the cable; and
a rotatable cable end shield mounted about the free end portion of the cable, the rotatable cable end shield comprising a housing having a top aperture in an upper portion thereof through which the free end portion of the cable is received, the housing encapsulating the free end portion of the cable and the ferrule for protection thereof by surrounding the free end portion of the cable in a circumferential direction and covering the free end portion of the cable, wherein the ferrule and the top aperture of the housing are configured to prevent withdrawal of the cable free end portion through the top aperture,
wherein the rotatable cable end shield is configured to rotate independently to the free end portion of the cable and the ferrule thereon.

18. The motor vehicle of claim 17, wherein the cable shield is rotatably mounted to rotate independently to the free end portion of the cable and the ferrule thereon.

19. The tire carrier system of claim 17, wherein the system comprises a shield tube, the cable extending through the shield tube and the hub carrier being slidably mounted on the shield tube for axial movement over the shield tube.

20. The tire carrier system of claim 19, wherein the shield tube is configured to surround and protect a portion of the cable extending upwardly from the rotatable cable end shield and through the shield tube.

21. A method for installing a spare tire carrier system with an anti-theft ferrule protection, the spare tire carrier system comprising:
a hub carrier constructed to receive the tire thereon, the hub carrier having a center aperture;
a raising and lowering mechanism comprising a cable and a rotational member for winding and unwinding the cable, the cable having a free end portion, the rotational member being coupled to an actuator and configured to retract the cable in a raising direction and extend the cable in a lowering direction;
a ferrule; and
a rotatable cable end shield comprising a top housing portion having a top aperture and a bottom housing portion;
wherein the method comprises:
feeding the cable through the center aperture of the hub carrier, and the top aperture of the top housing portion;
attaching a ferrule to the cable at the free end portion of the cable such that the ferrule prevents retraction of the cable through the top aperture of the top housing portion; and
securing the bottom housing portion to the top housing portion such that the ferrule is encapsulated inside the rotatable cable end shield and the bottom housing portion is permanently attached to the top housing portion to prevent removal of the ferrule from the rotatable cable end shield, the rotatable cable end shield being rotatable independently to the free end portion of the cable and the ferrule thereon.

22. The method of claim 21, wherein the top housing portion and the bottom housing portion each include at least one alignment tab, wherein the securing of the bottom housing portion to the top housing portion further includes aligning the at least one alignment tab on the top housing portion with the at least one alignment tab on the bottom housing portion.

23. The method of claim 21, wherein the system includes a shield tube, wherein feeding the cable additionally includes feeding the cable through the shield tube.
